(19) United States
(12) Patent Application Publication
(10) Pub. No.: US 2025/0321577 A1
(43) Pub. Date: Oct. 16, 2025

(54) Method and System for Teleoperated Driving based on Digital Twin

(71) Applicant: AUTONOMOUS VEHICLE GENIUS, Cheongju-si (KR)

(72) Inventor: Keon Il KIM, Cheongju-si (KR)

(21) Appl. No.: 19/177,759

(22) Filed: Apr. 14, 2025

(30) Foreign Application Priority Data
Apr. 12, 2024 (KR) 10-2024-0049562

(51) Int. Cl. G05D 1/224; B60W 30/09; B60W 30/12; B60W 60/00; G08G 1/16

(52) U.S. Cl. CPC G05D 1/2247; B60W 30/09; B60W 30/12; G08G 1/167; B60W 60/00; B60W 2420/403; B60W 2510/20; B60W 2520/10; B60W 2554/402; B60W 2556/45; B60W 2710/18

(57) ABSTRACT

a method and an apparatus for teleoperated driving based on digital twin are disclosed. According to an aspect of the present disclosure, there is provided a computer-implemented method for teleoperated driving based on digital twin, comprising: receiving, from autonomous driving mobility, message data including information about the autonomous driving mobility and information about a surrounding object; generating, based on the message data, virtual mobility and a virtual object respectively corresponding to the autonomous driving mobility and the surrounding object on a virtual environment simulating an environment in which the autonomous driving mobility is driving; and transmitting an operation input of a teleoperated driver for the virtual mobility to the autonomous driving mobility.

### CROSS-REFERENCE TO RELATED APPLICATIONS

This application is based on, and claims priority from, Korean Patent Application Number 10-2024-0049562, filed Apr. 12, 2024, the disclosure of which is incorporated by reference herein in its entirety.

### TECHNICAL FIELD

The present disclosure relates to a method and an apparatus for teleoperated driving based on digital twin.

### BACKGROUND

The statements in this section merely provide background information related to the present disclosure and do not necessarily constitute prior art.

The future automotive market is developing around the connectivity of drivers and vehicles, vehicles and their surrounding environment, and transportation infrastructure and everyday life elements. In this context, research related to the development of autonomous vehicles is actively being conducted, and in particular, technical research on a teleoperated control solution for responding to a dangerous situation that may occur during test driving or road driving is becoming important.

Visual information and various cognitive information transmitted from a camera mounted on the vehicle are essential for teleoperated control of the autonomous vehicle. When the control is switched to the control center of the autonomous vehicle, the teleoperated driver of the control center makes important use of the video information transmitted from the vehicle, in particular the videos of the front side and the side side. An existing teleoperated control system transmits and receives video videos of SD image quality (640*480 pixels) and 30 FPS frames at a transmission rate of 1 Mbps. Transmission of such real-time video information requires significant network communication resources. Such high resources have additional problems such as high bandwidth demands, data transmission delays, security vulnerabilities, etc. and remain a significant problem of teleoperated control.

### SUMMARY

According to an aspect of the present disclosure, there is provided a computer-implemented method for teleoperated driving based on digital twin is provided, the computer-implemented method comprising: receiving, from autonomous driving mobility, message data including information about the autonomous driving mobility and information about a surrounding object; generating, based on the message data, virtual mobility and a virtual object respectively corresponding to the autonomous driving mobility and the surrounding object on a virtual environment simulating an environment in which the autonomous driving mobility is driving; and transmitting an operation input of a teleoperated driver for the virtual mobility to the autonomous driving mobility

According to another aspect of the present disclosure, a teleoperated control device is provided, the teleoperated control device comprising: a memory storing instructions; and at least one processor, wherein the at least one processor is configured to execute the instructions to: receive, from autonomous driving mobility, message data including information about the autonomous driving mobility and information about a surrounding object; and generate, based on the message data, a virtual mobility and a virtual object respectively corresponding to the autonomous driving mobility and the surrounding object on a virtual environment simulating an environment in which the autonomous driving mobility is driving; transmit an operation input of a teleoperated driver for the virtual mobility to the autonomous driving mobility.

According to another yet aspect of the present disclosure, a computer program stored in a computer-readable recording medium for executing each process included in the aforementioned method is provided.

### BRIEF DESCRIPTION OF THE DRAWINGS

FIG. 1 is a block diagram schematically illustrating a teleoperated driving system according to an embodiment of the present disclosure.

FIG. 2 is a block diagram schematically illustrating autonomous driving mobility according to an embodiment of the present disclosure.

FIG. 3 is a block diagram schematically illustrating a teleoperated control device according to an embodiment of the present disclosure.

FIG. 4 is a diagram illustrating a teleoperated driver interface of a teleoperated control device according to an embodiment of the present disclosure.

FIG. 5 is an illustrative diagram schematically illustrating an information flow of a teleoperated driving system according to an embodiment of the present disclosure.

FIG. 6 is a flowchart illustrating a teleoperated driving method according to an embodiment of the present disclosure.

FIG. 7 is a block diagram schematically illustrating an example computing device that may be used to implement a method or apparatus according to the present disclosure.

### DETAILED DESCRIPTION

An object of the present disclosure is to provide a method and an apparatus that may effectively improve the efficiency of a teleoperated driving system by simulating real mobility and surrounding objects in a digital world based on data in the form of a message of a very small capacity, and performing teleoperated control on the digital world.

The problems to be solved by the present invention are not limited to the problems mentioned above, and other problems not mentioned will be clearly understood by a person skilled in the art from the following description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

In describing the components of an embodiment according to the present disclosure terms such as first, second, i), ii), a), b), etc., may be used. Such term are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

The following detailed description, together with the accompanying drawings, is intended to describe example embodiments of the present disclosure, and is not intended to represent the only embodiments in which the present disclosure may be practiced.

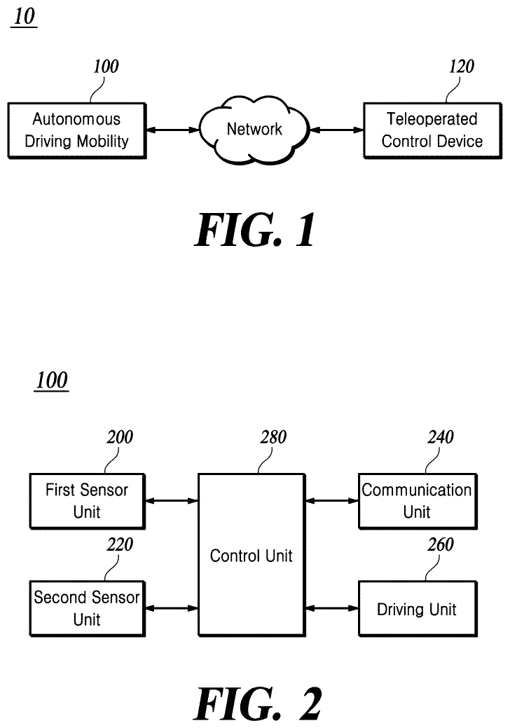

FIG. 1 is a block diagram schematically illustrating a teleoperated driving system according to an embodiment of the present disclosure.

A teleoperated driving system 10 may include an autonomous driving mobility 100 and a teleoperated control device 120. Hereinafter, it is assumed that the autonomous driving mobility 100 is an autonomous vehicle, but this is for convenience of description, and the present disclosure is not limited thereto. That is, the autonomous driving mobility may be understood as a concept including not only an autonomous vehicle but also unmanned mobility such as an autonomous logistics robot.

The teleoperated control device 120 is a device for teleoperatedly controlling the autonomous driving mobility 100. The teleoperated control device 120 may be introduced for transition to a Minimal Risk Condition (MRC) when the autonomous driving mobility 100 loses driving capability, such as a complicated traffic situation or an unexpected failure.

The teleoperated control device 120 may be provided, for example, in an integrated control center. A teleoperated driver in the integrated control center may grasp the state of the autonomous driving mobility 100 in real time through the teleoperated control device 120 and take appropriate measures if necessary.

In the present disclosure, information about the autonomous driving mobility 100 may be provided on a digital world (i.e., a digital twin) that simulates information of the real world. The teleoperated control device 120 may emulate and simulate autonomous driving mobility 100 in a virtual digital environment. The teleoperated control device 120 may collect data on the autonomous driving mobility 100 (e.g., location, speed, direction, etc.) and data on surrounding object (e.g., people, vehicles, obstacles, etc.) from the autonomous driving mobility 100 in the real world, and implement the data in real time within the digital world. The teleoperated driver may recognize various information including the location and movement of the autonomous driving mobility and the surrounding object in real time based on a video visualizing the digital world.

The autonomous driving mobility 100 and the teleoperated control device 120 may be communicatively coupled to each other via a network. For example, a teleoperated control (or teleoperated driving) technology may be used as an application service of Cellular Vehicle to Everything Communication (C-V2X).

FIG. 2 is a block diagram schematically illustrating autonomous driving mobility according to an embodiment of the present disclosure.

Referring to FIG. 2, the autonomous driving mobility 100 may include all or some of a first sensor unit 200, a second sensor unit 220, a communication unit 240, a driving unit 260, and a control unit 280. Not all blocks shown in FIG. 2 are essential components, and some blocks included in the autonomous driving mobility 100 may be added, changed, or deleted in other embodiments. On the other hand, the components shown in FIG. 2 represent functionally distinct elements, and may be implemented in a form in which at least one component is integrated with each other in an actual physical environment.

Each component of the autonomous driving mobility 100 may exchange signals through an internal communication system (not shown). The signal may include data. The internal communication system may use at least one communication protocol (e.g., CAN communications, Ethernet, UART communication, LIN, FlexRay, MOST).

The first sensor unit 200 may collect external situation information of the vehicle. Here, the external situation information may include a video capturing the surroundings of the autonomous driving mobility 100, a position of a surrounding object (e.g., person, other mobility, other obstacles, etc.), a relative position of the surrounding object with respect to the autonomous driving mobility 100, and/or a relative speed between the surrounding objects with respect to the autonomous driving mobility 100. The relative position of the surrounding object may include a distance between the autonomous driving mobility 100 and the object and/or a direction in which the object is located based on the autonomous driving mobility 100.

The first sensor unit 200 may include one or more of a camera, a radar, a lidar, an ultrasonic sensor, and an infrared sensor. The first sensor unit 200 may include a plurality of homogeneous or heterogeneous sensors. According to an implementation, the first sensor unit 200 may further include, but is not limited to, a processor for detecting a surrounding object and/or determining a type of the surrounding object and a physical quantity for the surrounding object, based on data output by the one or more sensors. In other embodiments, the functions described above may be performed by the control unit 280.

The second sensor unit 220 may collect status information of the autonomous driving mobility 100. Here, the state information may include a rotation speed of the steering wheel provided in the autonomous driving mobility 100, a rotation angle of the steering wheel, an operating state of the acceleration/deceleration pedal, an operating state of the direction indicator light, an operating state of a lighting device, a driving speed, an acceleration, a rotational angular speed of the autonomous driving mobility 100, a posture of the autonomous driving mobility 100, and/or Global Positioning System (GPS)-based position information. To this end, the second sensor unit 220 may include a GPS receiver, an inertial measurement unit (IMU), a vehicle speed sensor, an acceleration/deceleration pedal position sensor, a steering sensor, and the like, but is not limited to the described sensors.

The communication unit 240 is a device for communicating with an external device. Here, the external device may be the teleoperated control device 120. The communication unit 240 may transmit information collected through the first sensor unit 200 and/or the second sensor unit 220 to the teleoperated control device 120, and/or receive control information for driving of the autonomous driving mobility 100 from the teleoperated control device 120.

The communication unit 240 may perform communication with an external device using a wireless communication scheme. The communication unit 240 may include telematics including a mobile network (5G, LTE, or the like), Wifi, Bluetooth, or the like, a V2X terminal and/or a network modem, or the like. As an example, the communication unit 240 may configure a message including information about the autonomous driving mobility 100 and/or information about a surrounding object, and transmit the message to the teleoperated control device 120 using a message transmission protocol (e.g., the Message Queuing Telemetry Transport (MQTT)) based on the Transmission Control Protocol (TCP). As another example, the communication unit 240 may receive an operation signal for the autonomous driving mobility 100 from the teleoperated control device 120 by using a message transmission protocol based on the TCP.

The driving unit 260 may control the operation of various driving devices related to the behavior of the autonomous driving mobility 100, such as steering, braking, and/or shifting of the autonomous driving mobility 100. The driving unit 260 may include, for example, a braking controller, a shift controller, a steering controller, a ramp controller, and/or a door controller, etc. The driving unit 260 may control a power train, a steering device, a brake, a direction indicator light, an emergency light, a door, or the like based on an operation signal received from the teleoperated control device 120. A manner in which the driving unit 260 controls the operation of various devices related to the behavior of the autonomous driving mobility 100 is common in the art, and thus a detailed description thereof will be omitted.

The control unit 280 may process information obtained from various devices in the autonomous driving mobility 100 and/or transmit information to other devices. For example, the control unit 280 may process information collected through the first sensor unit 200 and/or the second sensor unit 220.

The processing by the control unit 280 may include reconfiguring data according to a form of a message to be transmitted through the communication unit 240. Additionally or alternatively, the processing may include distinguishing a relative position and/or type of a surrounding object based on the signal sensed by the first sensor unit 200. Additionally or alternatively, the processing may include combining information recognized based on the first sensor unit 200 (e.g., a relative position of the surrounding object) and information recognized based on a second sensor unit 220 (e.g., an absolute position of the autonomous driving mobility) to estimate an absolute position of a surrounding object.

The control unit 280 may transmit the collected information or the processed information to the communication unit 240. The control unit 280 may transmit the control information received from the teleoperated control device 120 via the communication unit 240 to the driving unit 260. The control unit 280 may be implemented as an embedded board.

The control unit 280 may convert a data format when transmitting information among components within the vehicle. For example, the control unit 280 may convert control information having a TCP communication format, acquired via the communication unit 240, into a CAN communication format and transmit it to the driving unit 260, thereby enabling control of steering, braking, and the like of the autonomous driving mobility 100.

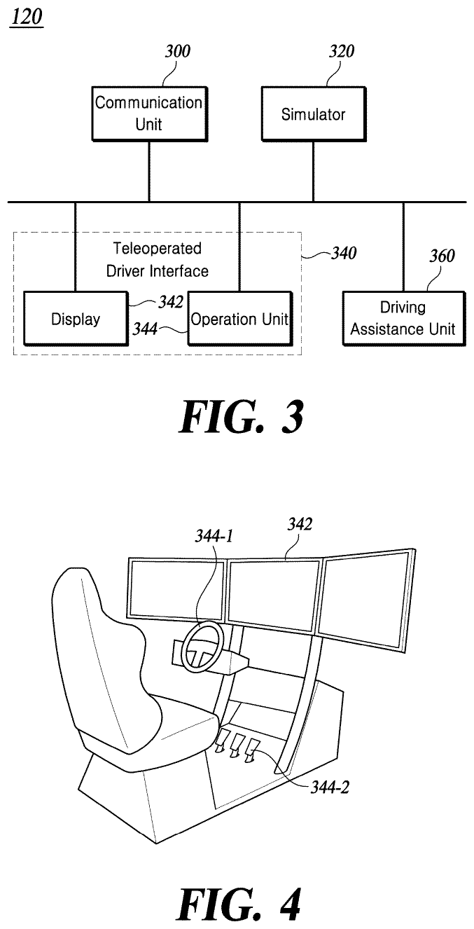

FIG. 3 is a block diagram schematically illustrating a teleoperated control device according to an embodiment of the present disclosure. FIG. 4 is a diagram illustrating a teleoperated driver interface of a teleoperated control device according to an embodiment of the present disclosure.

Referring to FIG. 3, the teleoperated control device 120 may include all or some of the communication unit 300, the simulator 320, the teleoperated driver interface 340, and the driving assistance unit 360. Not all blocks shown in FIG. 3 are essential components, and some blocks included in the teleoperated control device 120 may be added, changed, or deleted in other embodiments. On the other hand, the components shown in FIG. 3 represent functionally distinct elements, and may be implemented in a form in which at least one component is integrated with each other in an actual physical environment. In addition, although the simulator 320 and the teleoperated driver interface 340 are represented as components of the teleoperated control device 120 in FIG. 3, according to another embodiment of the present disclosure, the simulator 320 and/or the teleoperated driver interface 340 may be implemented as a separate stand-alone device that connects with the teleoperated control device 120 through a wired or wireless network.

The communication unit 300 may transmit and receive various types of information to and from the autonomous driving mobility 100. The communication unit 300 may receive information about the autonomous driving mobility 100 or a surrounding object from the autonomous driving mobility 100, and/or transmit an operation signal for teleoperated driving to the autonomous driving mobility 100. In this case, the communication unit 300 may transmit and receive various types of information based on a TCP-based message transmission protocol, but is not limited thereto.

The simulator 320 implements a digital world (i.e., a digital twin) that simulates the real world based on the message received from the autonomous driving mobility 100.

The simulator 320 may generate virtual mobility and a virtual object corresponding to the autonomous driving mobility and the surrounding object, respectively, on a virtual environment in which the autonomous driving mobility 100 simulates the environment. The virtual environment may be, for example, a three-dimensional virtual environment based on a high-precision map (HD Map). In the virtual environment, lanes, road conditions, and the like may be implemented in the same manner as the actual environment in which the autonomous driving mobility 100 drives.

The simulator 320 may perform, based on the message received from the autonomous driving mobility 100, synchronization in real time such that the state of the virtual mobility becomes the same as the state of the autonomous driving mobility 100. The simulator 320 may generate, based on the message received from the autonomous driving mobility 100, one or more virtual objects and/or perform synchronization in real-time such that the state of the virtual object is the same as the state of the surrounding object of the autonomous driving mobility 100.

The simulator 320 may generate a video visualizing a virtual environment in which virtual mobility and a virtual object are implemented (hereinafter, a simulation video). A scale and viewpoint of the virtual environment represented in the video may be varied based on a setting value input in advance and/or input in real time by the teleoperated driver. To this end, the simulator 320 may support one or more scales and viewpoints (e.g., first-person view, top-view, side-view, quarter-view, back-view, etc.).

The teleoperated driver interface 340 provides information on the autonomous driving mobility 100 to the teleoperated driver, and receives an operation input of the teleoperated driver for teleoperated driving of the autonomous driving mobility 100. To this end, the teleoperated driver interface 340 may include a display 342 and an operation unit 344.

The display 342 may output a simulation video generated by the simulator 320. Accordingly, the teleoperated driver performs teleoperated driving while viewing virtual mobility on the virtual environment. That is, the teleoperated driver may perform teleoperated driving by looking at a digital world in which both the autonomous driving mobility 100 and the surrounding objects are implemented, rather than looking at a video (e.g., a front video or the like) containing only limited information captured by the autonomous driving mobility 100. The angle at which the virtual mobility is viewed through the simulation video, the visual field, and/or the accumulation, etc., may be set to a value that is easy for the teleoperated driver to use.

Optionally, an AVM video captured by the autonomous driving mobility may be visually provided to the teleoperated driver along with the simulation video. In one embodiment, the teleoperated driver interface 340 may include a plurality of displays to simultaneously output two or more videos. In another embodiment, two or more videos may be displayed separately in a plurality of areas in one display, or may be composited (or overlaid) and output together through one display.

The operation unit 344 may receive an input corresponding to an operation for controlling the autonomous driving mobility 100. To this end, the operation unit 344 may include all or some operation means such as a steering wheel 344-1, an acceleration/deceleration pedal 344-2, and the like, as illustrated in FIG. 4. The operation unit 344 may further include a button (not shown) for receiving various setting values from the teleoperated driver. In addition, the operation unit 344 may further include a steering sensor, an acceleration/deceleration pedal position sensor, and the like for sensing an operation state by the teleoperated driver. The operation unit 344 may generate an operation signal corresponding to a rotation speed of the steering wheel 344-1, a rotation angle of the steering wheel 344-1, and an operating state of the acceleration/deceleration pedal 344-2. The operation signal may be transmitted to the autonomous driving mobility 100 via the communication unit 300. Accordingly, the teleoperated driver may teleoperatedly control the autonomous driving mobility 100 by operating the steering wheel 344-1 and the acceleration/deceleration pedal 344-2. According to an implementation example, the operation unit 344 may further include an operation means for operating the direction indicator light, the lighting device, and/or the door of the autonomous driving mobility 100, and a sensor for sensing an operation of the teleoperated driver thereto.

The driving assistance unit 360 may generate recognition information and/or control information for assisting the driving of the teleoperated driver. According to an implementation, the driving assistance unit 360 may generate a command to operate the driving operation unit 344 or directly control the autonomous driving mobility 100.

The driving assistance unit 360 may provide an Advanced Driver Assistance System (ADAS) function to the teleoperated driver based on the message received from the autonomous driving mobility 100 and/or the virtual environment implemented therefrom. The ADAS function may include one or more of a Lane Departure Warning System (LDWS), a Lane Keeping Assist (LKA), Forward Collision-Avoidance (FCA) Warning, Forward Collision Warning (FCW), Autonomous Emergency Braking (AEB), Parking Assist System (PAS), Parking Collision-Avoidance Assist (PCA), Blind Spot Detection (BSD), and a Pedestrian Collision Warning system (PD collision warning system).

The driving assistance unit 360 may detect lane departure of the autonomous driving mobility 100 based on the position and/or posture of the virtual mobility implemented on the virtual environment. When the autonomous driving mobility 100 is out of the lane under the control of the teleoperated driver, the driving assistance unit 360 may provide an alarm to the teleoperated driver. As an example, the driving assistance unit 360 may visually warn the teleoperated driver of the lane departure by blinking the display 342 and/or a separate display device (e.g., an LED or the like). As another example, the driving assistance unit 360 may float a specific graphical object (e.g., a warning UI) in at least one area of the simulation video, or may impart a specific graphical effect to a graphical object (such as a lane or virtual mobility implemented on a virtual environment) in the simulation video. As another example, the driving assistance unit 360 may audibly and/or tactilely alert the teleoperated driver of the lane departure via output means such as a speaker and/or a haptic device.

The driving assistance unit 360 may be equipped with a Lane Keeping Assist System (LKAS) that prevents lane departure by operating the steering means of the autonomous driving mobility 100 and/or the operation unit 344 when the autonomous driving mobility 100 is out of the lane by the operation of the teleoperated driver. As an example, when the driving assistance unit 360 operates the steering wheel 344-1 of the operation unit 344, the operation unit 344 may generate an operation signal corresponding to a state (e.g., a speed and an angle of the steering wheel) of the steering wheel 344-1. As another example, the driving assistance unit 360 may directly generate an operation signal for controlling the steering of the autonomous driving mobility 100 when the autonomous driving mobility 100 is out of the lane by the operation of the teleoperated driver. The generated operation signal is transmitted to the communication unit 300 and the operation unit 344 so that the steering of the autonomous driving mobility 100 is controlled and a steering wheel 520-2 of the operation unit 354 is operated, thereby preventing the teleoperated driver from feeling uncomfortable.

The driving assistance unit 360 may detect a dangerous situation of the autonomous driving mobility 100 based on the state of the virtual mobility implemented on the virtual environment and/or the operation input of the teleoperated driver, and operate the emergency braking device of the autonomous driving mobility 100. For example, the driving assistance unit 360 may predict the driving of the virtual mobility based on the operation input of the teleoperated driver, and determine the possibility of collision between the virtual mobility and the virtual object. The virtual object may include an object generated based on a message received from the autonomous driving mobility 100, as well as a static obstacle that is pre-reflected on the virtual environment. When a dangerous situation is detected, the driving assistance unit 360 may generate an operation signal for operating the emergency braking device mounted on the autonomous driving mobility 100. That is, the driving assistance unit 360 may determine the possibility of occurrence of an accident of the autonomous driving mobility 100 based on the information on the virtual environment, and generate an operation signal for instructing the autonomous driving mobility to decelerate and/or stop. In another example, the driving assistance unit 360 may operate the steering wheel 344-1 and/or the acceleration/deceleration pedal 344-2 of the operation unit 344 as a dangerous situation is detected. When the driving assistance unit 360 operates the steering wheel 344-1 and/or the acceleration/deceleration pedal 344-2, the operation unit 344 may generate an operation signal corresponding to the state of the steering wheel 344-1 and/or acceleration/deceleration pedal 344-2.

In some examples, the driving assistance unit 360 and may include a learning model which is a deep learning-based model trained in advance to recognize a static obstacle such as a building and the like and a dynamic obstacle such as a pedestrian from a simulation video and/or an AVM video. In addition, the driving assistance unit 360 may further include a learning unit (not shown) for training the learning model in advance. The learning unit may train the learning model in advance using supervised learning, unsupervised learning, semi-supervised learning, and/or reinforcement learning. For example, the learning unit may train a learning model by utilizing a video and a label related to an object present in the video (e.g., a bounding box indicating a position of the object and/or an identifier indicating a type of the object) as training data. On the other hand, a specific method by which the learning unit trains the learning model based on the training data is common in the art, and detailed description thereof will be omitted.

As described above, the driving assistance unit 360 according to an embodiment of the present disclosure may provide various driving assistance functions to the teleoperated driver, thereby providing convenience and stability as if the teleoperated driver is driving in the autonomous driving mobility 100.

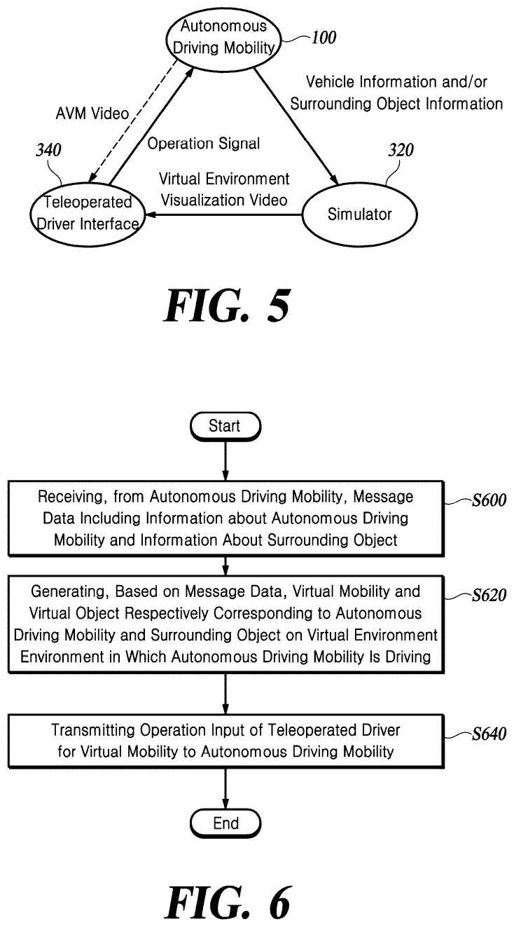

FIG. 5 is an illustrative diagram schematically illustrating an information flow of a teleoperated driving system according to an embodiment of the present disclosure.

In conventional teleoperated driving system, the teleoperated driver has received all the information necessary for teleoperated driving directly from the autonomous driving mobility. In particular, a real-time video (e.g., a front video, a rear video, and/or a lateral video) captured by the autonomous driving mobility 100 is most mainly transmitted and used for teleoperated driving. This is a very large capacity, a large load in terms of cost and network resources.

On the other hand, in the teleoperated driving system 10 according to an embodiment of the present disclosure, the digital twin technology is utilized to implement the real world including the autonomous driving mobility 100 as well as its surrounding objects as it is in the digital world (i.e., the virtual environment), and the teleoperated driver recognizes information necessary for teleoperated driving based on this digital world.

The autonomous driving mobility 100 may provide the simulator 320 with information for generating, on the virtual environment, virtual mobility and a virtual object corresponding to the autonomous driving mobility 100 and the surrounding object, respectively. On the other hand, although FIG. 5 illustrates that the autonomous driving mobility 100 directly communicates with the simulator 320 and the teleoperated driver interface 340, the present disclosure is not limited thereto, and the simulator 320 and the teleoperated driver interface 340 may communicate with the autonomous driving mobility 100 via the communication unit 300.

Table 1 illustrates information necessary for the simulator 320 to implement virtual mobility.

TABLE 1

| No | Name | Type | Unit | Remarks |
|---|---|---|---|---|
| 1 | position | vector3 | m | current location of autonomous |
| | | | | driving mobility (x, y, z) |
| 2 | rotation | vector3 | deg | current posture of autonomous |
| | | | | driving mobility (roll, pitch, yaw) |
| 3 | velocity | float64 | km/h | current speed of autonomous |
| | | | | mobility |
| 4 | steering_angle | float64 | deg | steering angle of autonomous |
| | | | | mobility |

The autonomous driving mobility 100 may transmit information necessary for implementation of the virtual mobility and the virtual object as data in the form of a message. The size of the message data containing such information is approximately within 70 bytes, which is a very small size compared to the video data.

The information for implementing the virtual mobility is information for generating and moving the virtual mobility on the virtual environment, and may include the current state (position, posture, speed, wheel direction, and the like) of the autonomous driving mobility. The information for implementation of the virtual object is a state information of the object around the autonomous driving mobility, and may include a type of the surrounding object and/or a relative position of the object with respect to the autonomous driving mobility 100. The autonomous driving mobility 100 may recognize surrounding objects through a mounted sensor (e.g., the first sensor unit 200 of FIG. 2), calculate a relative position of the object, and then transmit the calculated position to the simulator 320. Additionally or alternatively, the autonomous driving mobility 100 may convert the relative position of the object into coordinates for a global coordinate system (or other coordinate system corresponding to the virtual environment) and send it to the simulator.

The autonomous driving mobility 100 may generate a message to be transmitted to the simulator 320 side by embedding the state information recognized in real time into a message format given in advance.

On the other hand, the simulator 320 receiving the message may implement the virtual mobility and the virtual object on the virtual environment in real time based on the information contained in the message.

The simulator 320 may provide a video visualizing the virtual environment to the teleoperated driver interface 340. Accordingly, the teleoperated driver may perform teleoperated driving while viewing virtual mobility implemented on the virtual environment. The information on the gear, the steering angle of the steering wheel, the accelerator pedal, and the brake pedal operated by the teleoperated driver may be carried in an operation signal and transmitted to the autonomous driving mobility 100. The operation signal may be transmitted in the same or similar format as the foregoing message, but is not limited thereto.

Optionally, for a direct visual field of the vicinity of the autonomous driving mobility 100, the teleoperated driver interface 340 may receive an Around View Monitoring (AVM) video from the autonomous driving mobility 100. When the corresponding option is selected, the network usage is slightly increased as compared to the option of transmitting and receiving only the message, but the network usage is still overwhelmingly low as compared to the conventional manner of performing teleoperated driving based on the front video, the rear video, and/or the lateral video.

FIG. 6 is a flowchart illustrating a teleoperated driving method according to an embodiment of the present disclosure.

The teleoperated control device 120 receives, from the autonomous driving mobility 100, message data including information about the autonomous driving mobility and information about a surrounding object (S600). The message data may be structured data representing information about the autonomous driving mobility 100 and information about the surrounding object in text or numbers. The information about the autonomous driving mobility 100 may include a current position, a current posture, a current speed, and a current steering angle of the autonomous driving mobility. Here, the message data may include three-dimensional vector data representing the current position and the current posture, respectively, and scalar data representing the current speed and the current steering angle, respectively. The information about the surrounding object may include a relative position of the surrounding object with respect to the autonomous driving mobility, or an absolute position of the surrounding object calculated based on the relative position. Additionally or alternatively, the information about the surrounding object may include a type of the surrounding object, estimated by the autonomous driving mobility.

Based on the message data, the teleoperated control device 120 generates a virtual mobility and a virtual object corresponding to the autonomous driving mobility 100 and the surrounding object, respectively, on a virtual environment simulating an environment in which the autonomous driving mobility is driving (S620).

The teleoperated control device 120 transmits the operation input of the teleoperated driver for the virtual mobility to the autonomous driving mobility 100 (S640). Optionally, the teleoperated control device 120 may provide an Advanced Driver Assistance System (ADAS) function to the teleoperated driver based on the virtual environment, the virtual mobility, the virtual object, and the operation input of the teleoperated driver. The ADAS function may include at least one of lane departure warning, lane keeping assistance, and emergency braking.

In steps S600 to S640, the teleoperated control device 120 may visually provide a video visualizing a virtual environment in which virtual mobility and a virtual object are implemented to the teleoperated driver. Here, a scale and a viewpoint of the virtual environment represented in the video may be varied based on an operation of the teleoperated driver.

In steps S600 to S640, the teleoperated control device 120 may selectively receive an Around View Monitoring (AVM) video captured by the autonomous driving mobility according to a request of the teleoperated driver. The received AVM video may be displayed separately from the video visualizing the virtual environment. For example, it may be output to a separate display device, or may be overlaid on at least a partial area on a video that visualizes a virtual environment.

In the foregoing, the operations described as being performed by the teleoperated control device 120 may be implemented by the functionality of one or more components of the teleoperated control device 120 being executed by at least one computing device.

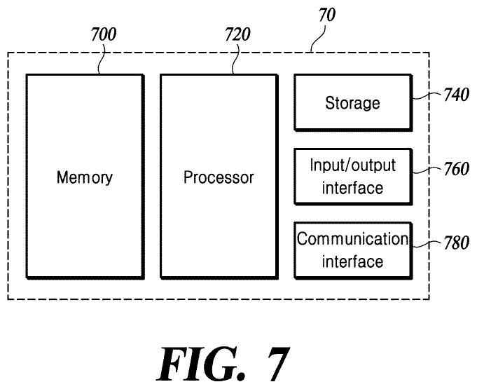

FIG. 7 is a block diagram schematically illustrating an example computing device that may be used to implement a method or apparatus according to the present disclosure.

FIG. 7 is a block diagram schematically illustrating an example computing device that may be used to implement a method or apparatus according to the present disclosure.

A computing device 70 may include some or all of a memory 700, a processor 720, a storage 740, an input/output interface 760, and a communication interface 780. The computing device 70 may structurally and/or functionally include at least some of the components 300 to 360 of the teleoperated control device 120. The computing device 70 may be a stationary computing device such as a desktop computer, server, etc., as well as a mobile computing device such as laptop computer, smart phone, etc. The computing device 70 may include any specialized hardware accelerator capable of processing particular operations in an efficient manner. For example, the computing device 70 may include a graphics processing unit (GPU), a vector processing unit (VPU), a tensor processing unit (TPU), or a neural processing unit (NPU).

The memory 700 may store a program that causes the processor 720 to perform a method or an operation according to various embodiments of the present disclosure. For example, the program may include a plurality of instructions executable by the processor 720, and the method or operations described above may be performed by executing the plurality of instructions by the processor 720. The memory 700 may be a single memory or a plurality of memories. In this case, information required to perform the method or operation according to various embodiments of the present disclosure may be stored in a single memory or may be stored in multiple memories. When the memory 700 is composed of a plurality of memories, the plurality of memories may be physically separated. The memory 700 may include at least one of a volatile memory and a non-volatile memory. The volatile memory includes a static random access memory (SRAM), a dynamic random access memory (DRAM), and the like, and the nonvolatile memory includes a flash memory and the like.

The processor 720 may include at least one core capable of executing at least one instruction. The processor 720 may execute instructions stored in the memory 700. The processor 720 may be a single processor or a plurality of processors.

The storage 740 maintains the stored data even if power supplied to the computing device 70 is cut off. For example, the storage 740 may include a non-volatile memory and may include a storage medium such as a magnetic tape, an optical disk, or a magnetic disk. The program stored in the storage 740 may be loaded into the memory 700 before being executed by the processor 720. The storage 740 may store a file written in a program language, and a program generated by a compiler or the like from the file may be loaded into the memory 700. The storage 740 may store data to be processed by the processor 720 and/or data processed by the processor 720.

The input/output interface 760 may provide an interface with an input device (e.g., the steering wheel 344-1 and the acceleration/deceleration pedal 344-2 of FIG. 4) and/or an output device (e.g., the display 342 of FIG. 4). A user may trigger execution of a program by the processor 720 via an input device and/or confirm a processing result of the processor 720 through an output device.

The communication interface 780 may provide access to an external network. The computing device 70 may communicate with other devices (e.g., the autonomous driving mobility 100 of FIG. 1) via the communication interface 780.

Each element of the device or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device, in addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

According to an embodiment of the present disclosure, by simulating real-world mobility and surrounding objects in a digital environment based on message-type data of very small size and performing teleoperated control within the digital world, the efficiency of the teleoperated driving system can be effectively improved.

According to an embodiment of the present disclosure, all information required for teleoperated driving can be transmitted and received using message-type data that requires only a few Kbps of transmission rate, instead of video data that typically requires a few Mbps. As a result, network bandwidth usage can be significantly reduced, contributing greatly to the reduction of communication costs. Moreover, since the amount of data transmitted and received between the vehicle and the teleoperated control device at any one time is reduced, stable data communication becomes possible. This enables resolution of issues caused by heavy data loads, such as latency and temporary disconnections.

According to an embodiment of the present disclosure, effective operation of autonomous driving mobility is supported, and when combined with the wider communication range offered by C-V2X, a more robust driver assistance system can be provided.

According to an embodiment of the present disclosure, by receiving not only information about the autonomous mobility itself but also information about surrounding objects from the autonomous mobility, the real world including surrounding objects can be implemented as-is in the digital world. Accordingly, the teleoperated driver can perform teleoperated driving based on the information represented in the digital world.

The effects of the present disclosure are not limited to those mentioned above, and other effects not explicitly stated will be clearly understood by those of ordinary skill in the art from the following description.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity, and the scope of the technical idea of the present embodiments is not limited by the illustrations. The scope of protection of the present embodiment should be interpreted based on the following claims, and all technical ideas within the equivalent scope should be construed as being included within the scope of rights of the present embodiment.

What is claimed is:

1. A computer-implemented method for teleoperated driving based on digital twin, the computer-implemented method comprising:
receiving, from autonomous driving mobility, message data including information about the autonomous driving mobility and information about a surrounding object;
generating, based on the message data, virtual mobility and a virtual object respectively corresponding to the autonomous driving mobility and the surrounding object on a virtual environment simulating an environment in which the autonomous driving mobility is driving; and
transmitting an operation input of a teleoperated driver for the virtual mobility to the autonomous driving mobility.

2. The computer-implemented method of claim 1, wherein the message data is structured data representing the information about the autonomous driving mobility and the information about the surrounding object in text or numbers.

3. The computer-implemented method of claim 1, wherein the information about the autonomous driving mobility includes a current position, a current posture, a current speed, and a current steering angle of the autonomous driving mobility.

4. The computer-implemented method of claim 3, wherein the message data includes three-dimensional vector data representing the current position and the current posture, respectively, and scalar data representing the current speed and the current steering angle, respectively.

5. The computer-implemented method of claim 1,
wherein the information about the surrounding object includes
a relative position of the surrounding object with respect to the autonomous driving mobility, or an absolute position of the surrounding object calculated based on the relative position.

6. The computer-implemented method of claim 5,
wherein the information about the surrounding object further includes
a type of the surrounding object, estimated by the autonomous driving mobility.

7. The computer-implemented method of claim 1, further comprising:
visually providing to the teleoperated driver a video visualizing the virtual environment in which the virtual mobility and the virtual object are implemented,
wherein a scale and a viewpoint of the virtual environment represented in the video are varied based on an operation of the teleoperated driver.

8. The computer-implemented method of claim 1, further comprising:
selectively receiving an Around View Monitoring (AVM) video captured by the autonomous driving mobility according to a request of the teleoperated driver.

9. The computer-implemented method of claim 1, further comprising:
providing an Advanced Driver Assistance System (ADAS) function to the teleoperated driver based on the virtual environment, the virtual mobility, the virtual object, and an operation input of the teleoperated driver, wherein the ADAS function includes at least one of lane departure warning, lane keeping assistance, or emergency braking.

10. A computer program stored in a computer-readable recording medium for executing each process included in the method according to claim 1.

11. A teleoperated control device, comprising:
a memory storing instructions; and at least one processor,
wherein the at least one processor is configured to execute the instructions to:
receive, from autonomous driving mobility, message data including information about the autonomous driving mobility and information about a surrounding object; and
generate, based on the message data, a virtual mobility and a virtual object respectively corresponding to the autonomous driving mobility and the surrounding object on a virtual environment simulating an environment in which the autonomous driving mobility is driving;
transmit an operation input of a teleoperated driver for the virtual mobility to the autonomous driving mobility.
